(19) United States
(12) Patent Application Publication
(10) Pub. No.: US 2009/0089261 A1
(43) Pub. Date: Apr. 2, 2009

(54) METHOD FOR RESOLVING FAILED SEARCH QUERIES

(75) Inventors: Ross A. Leher, Englewood, CO (US); Jeffrey Burinda, Centennial, CO (US)

Correspondence Address: HENSLEY KIM & HOLZER, LLC, 1660 LINCOLN STREET, SUITE 3000, DENVER, CO, 80264, US

(73) Assignee: WAND, INC., Denver, CO (US)

(21) Appl. No.: 12/243,763

(22) Filed: Oct. 1, 2008

Related U.S. Application Data
(60) Provisional application No. 60/976,563, filed on Oct. 1, 2007.

(51) Int. Cl. G06F 7/06; G06F 17/30

(52) U.S. Cl. 707/3; 707/E17.014

(57) ABSTRACT

A query resolution system can be used for redirecting, refining, and/or resolving user query terms. A query resolution system may resolve and enhance user query terms, received from a user or a search portal, through providing relational matches to the user query terms using a resolver taxonomy. The resolution system may include a cross-reference map linking the resolver taxonomy with an initial taxonomy in the search portal. Utilization of the resolver system may provide the user with search results from the search portal that the user would not have seen without application of the resolver system.

### CROSS-REFERENCE TO RELATED APPLICATIONS

This application claims benefit of United States Provisional Application No. 60/976,563, entitled “Method for Resolving Failed Search Queries” and filed on Oct. 1, 2007, which is specifically incorporated herein by reference for all that it discloses and teaches.

### TECHNICAL FIELD

The present disclosure broadly relates to information management and retrieval and more particularly relates to a query resolution service for redirecting, refining, and/or resolving search queries.

### BACKGROUND

Even before the information age with computers, the Internet, databases, and search engines, people have sought ways of organizing and categorizing data and information. For example, a library houses thousands of volumes of information in the form of novels, reference materials, encyclopedias, etc. Another example of categorized data is a phonebook, which lists alphabetically and categorically individual and business phone numbers, etc.

A library generally has a categorization system to enable a user to find the particular information for which they are looking. Broadly, a library may be physically organized into subject areas where books are shelved based on their subject matter, such as science, history, art, etc. However, to find a particular reference on, for instance, a book about the history of aeronautical development it would be rather inefficient and tedious to physically search through each book in the history section. Accordingly, libraries have developed a system of categorizing and organizing their books such that they are much easier to find. A categorization system is sometimes referred to as a taxonomy, which is simply a schema for categorizing like items together such that they are easier to search for and locate. In the case of a library card catalog the taxonomy consists of organizing books by subject matter, author, and title. Accordingly, if a reader were looking for a book on the history of aeronautical development they might first search the subject catalog under history and then under the subcategory of technology and then finally the term aeronautical. In some cases the reader may be looking for a subject that is not listed in the card catalog but most likely exists somewhere in at least one of the texts in the library. In other words the taxonomy is somewhat crude because it lacks sufficient detail and organization. In such a case the reader could consult with the librarian who has knowledge of each of the books and their various subject matters. By consulting with the librarian the reader is in effect accessing a more detailed taxonomy of the library's contents.

The phonebook represents another example where a taxonomy is used to facilitate locating information. The phonebook lists phone numbers and addresses for individuals in alphabetical order. More relevant to the present discussion is the fact that the phonebook also lists information for businesses providing products and services. The phonebook lists information for businesses by an alphabetical listing of categories. Under each category, businesses matching that description are listed along with their name, address, and phone number. This type of taxonomy provides a useful way to search for a particular business.

In today's information age the Internet and even local databases provide an incredible amount of information. This information, similar to the information in a library or in a phonebook, is usually searched by some method based on a taxonomy in order to retrieve results. For example, many phone companies have listed their phonebooks via the Internet and have made them available to customers through a web-based search screen. There are many such compilations of information that have a product and service based category structure including E-Commerce catalogs, search engines, online libraries, encyclopedias, dictionaries, etc.

Although these types of databases are somewhat useful for searching, they have at least one drawback. If a user is searching for a category that is not included in the taxonomy for the particular database being searched, the search will usually fail. Because these database providers do not have a means of resolving failed searches the user usually must try different search terms, which will hopefully match one of the categories in the taxonomy.

Accordingly, there is a need for a search term taxonomy, which includes structured search query terms and meta-data terminology, which would cover nearly all of the queries that may be entered by users in a local search environment. With this type of all-encompassing taxonomy, nearly any search would return a relevant result. There is a further need for a query resolver that can disambiguate terms as well as correct spelling and recognize synonyms. There is yet a still further need for a query resolver that is conveniently adaptable to work with many types of search engines and environments, including multi-lingual environments.

### SUMMARY

In order to resolve a search query a resolver service uses a robust resolver taxonomy. In some implementations, the resolver taxonomy can be cross-referenced to a search system's taxonomy. The resolver taxonomy can be integrated into enterprise class applications including, but not limited to, search and discovery, knowledge management, content management, document retrieval and more. Additionally, the resolver taxonomy may also have a local initial taxonomy which can enhance the results of local search-style engines and portals on the Internet to reduce failed searches. The local initial taxonomy can include structured local search query terms and meta-data terminology covering nearly all of the queries that are entered by users in a local search environment. When this local search vocabulary is combined with advanced spell check and approximate match search technology, there is a very high probability that nearly any search will return a relevant result, thus providing a satisfying experience for local search users and driving targeted business to local search advertisers.

In addition to the above taxonomies the resolver service may include specialty taxonomies pertaining, for example, to industry-specific jobs and skills, travel, and medical terms. These specialty taxonomies may provide a robust and intuitive search interface for any product and service or database. These specialty taxonomies could be adapted for use with other resolver taxonomies, for use in an enterprise environment for vendor identification and electric cataloging, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic representation of a query resolution service in a representative search environment.

FIG. 2 is a flow chart illustrating the architecture of the query resolution service in a multiple taxonomy environment.

FIG. 3 is a flowchart illustrating an exemplary embodiment of the query resolution service in a resolver system.

FIG. 4 is a flowchart illustrating an exemplary embodiment of the query resolution service in a multiple taxonomy environment.

FIG. 5 illustrates an example system that may be useful in implementing the described technology.

### DETAILED DESCRIPTION

Described herein is a query resolution service useful for resolving searches to more effectively return relevant results. In an exemplary embodiment a search system subscribes to the query resolution service, described below, in order to resolve failed queries input by the search system or one of the search system's users. For example, the search system could be an online phonebook, an E-Commerce catalog, a search engine, an online library, an online encyclopedia, an online dictionary, etc. In one implementation, these search parties in turn allow users to search their databases. In one implementation, users can search database taxonomies via a computer system, such as a personal computer connected to the Internet. It should be understood that various computer environments and connections may be employed in the implementation of the present invention.

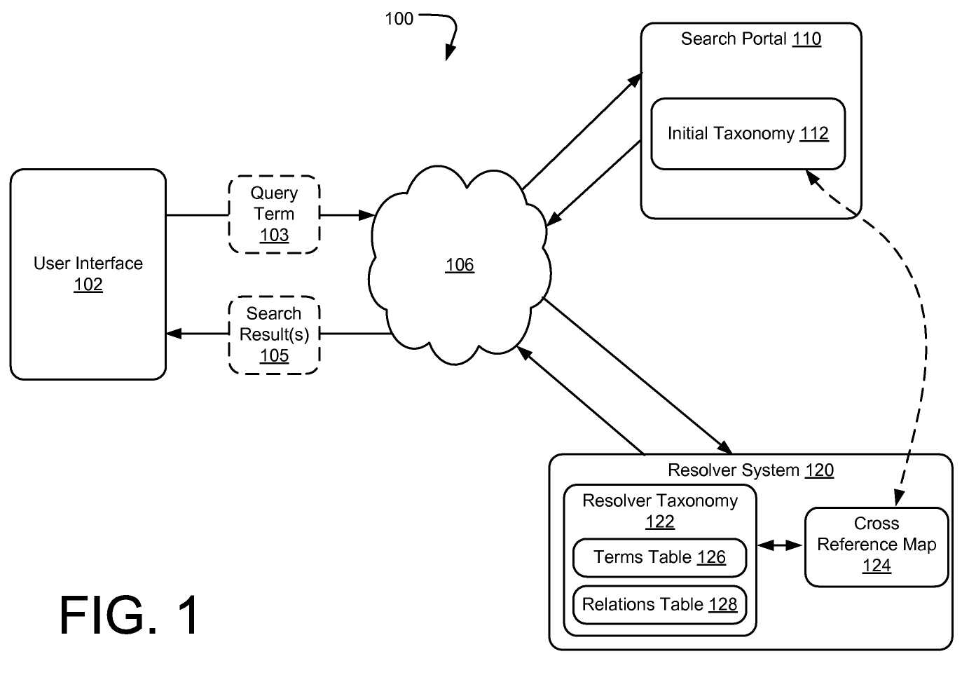

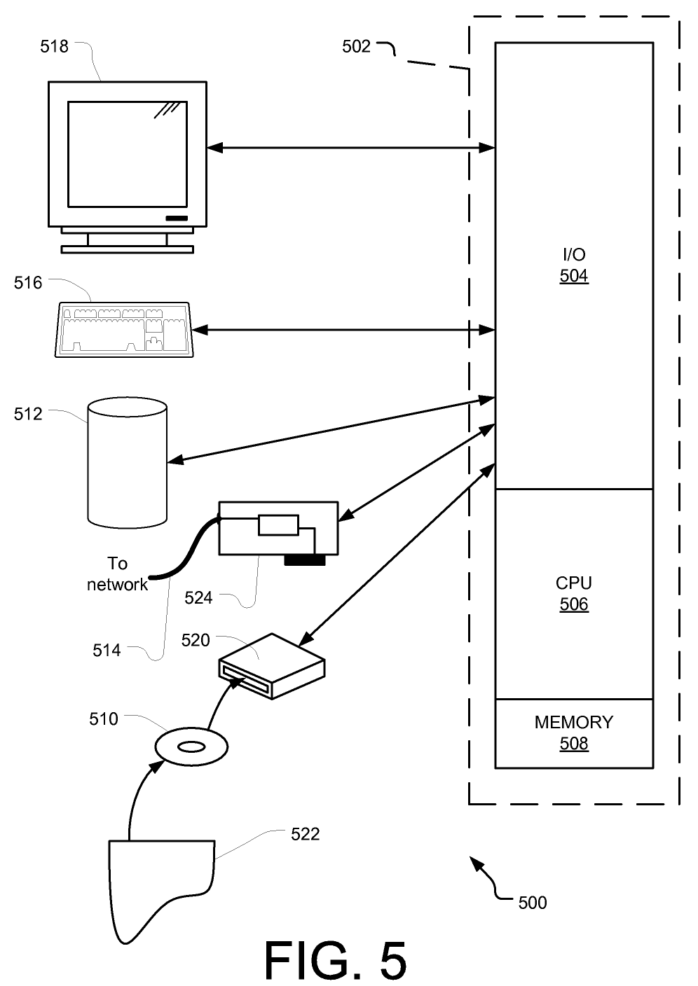

FIG. 1 is a schematic representation of a resolver system 120 in a representative search environment 100. FIG. 1 includes a user interface 102, a search portal 110, which includes an initial taxonomy 112, and a resolver system 120, which includes a resolver taxonomy 122, and cross-reference map 124. Resolver taxonomy 122 may include a terms table 126 and a relations table 128. The user interface 102 may be implemented on a variety of computer systems, such as but not limited to, computer systems described with regard to FIG. 5. In one implementation, the user interface 102, such as a user computer system, may be connected directly to the search portal 110 or via a suitable communications interface 106, such as the Internet with a search page interface. In another implementation, the user interface 102, may be connected directly to resolver system 120 or via a suitable communication interface 106, such as the Internet with a search page interface. In one implementation, where connected through the Internet, the search portal 110 interfaces with the resolver system 120 through web services call procedures.

In another implementation, the resolver system 120 could interface with the search portal 110 as an application installed on the search portal 110. In such implementations, the resolver system 120 may be preconfigured to interface with the search portal 110 prior to installation

User interface 102 allows a user to input a query term 103. As used in this application, a query term 103 could include a single word, a phrase, a question or any other combinations of words to indicate the user's request. In some implementations, the query term 103 is sent to the search portal 110 to attempt to generate search results 105. In such implementations, if the search portal 110 cannot match the query term 103 to terms in the initial taxonomy 112, then the query term 103 is transmitted to the resolver system 120.

Cross-reference map 124 provides a link between a resolver taxonomy 122 of resolver system 120 and category headings in the initial taxonomy 112. In one implementation, it is assumed that the initial taxonomy 112 has a backbone categorization schema which is less refined than that of the resolver taxonomy 122. In other words, the cross-reference map 124 provides a cross reference between the resolver taxonomy 122 and initial taxonomy 112. In some implementations, the cross-reference map 124 is generated specifically for the initial taxonomy 112 of the search portal 110 while the resolver taxonomy 122 is a general use robust taxonomy. In some implementations, both the cross-reference map 124 and the resolver taxonomy 122 are generated specifically to supplement and/or augment the initial taxonomy 112 of the search portal 110. In some implementations, the cross-reference map 124 and the resolver taxonomy 122 are updated and refined with data, for example, query log analysis, or term integration. In some implementations, these updates are provided in a real-time manner. In other implementations, updates are provided periodically via a predetermined schedule.

In order to illustrate the interconnection and operation of the components illustrated in FIG. 1, assume, for example, that there is a user interested in finding furniture for their office. In particular, assume the user searches an Internet phonebook listing by inputting the search term, “computer desk.” For purposes of illustrating this example, the initial taxonomy 112 of the Internet phonebook listing could be phonebook category headings. Furthermore, for the purposes of illustrating this example, in contrast to the resolver taxonomy 122, the phonebook taxonomy 112 is less detailed and contains only the category of “office equipment and furniture,” which includes the specific records for companies in that type of business. The resolver taxonomy 122 may include more details, such as, a category called “office furniture,” which may include, for example, more specific categories of computer desks, wooden desks, metal desks, modular desks, wooden chairs, and leather chairs. If the Internet phone book listing is unable to generate a match with the search term, the search term may be passed to the resolver system 120. The resolver taxonomy 122 compares the search term (term 1) to the terms table 126 with the cross-reference map 124 to determine if it is linked externally to the initial taxonomy 112, such as the phonebook taxonomy, with an external code.

Continuing the above example, in the resolver taxonomy 122, “computer desk” is cross referenced to the phonebook taxonomy category of “office equipment and furniture.” Once the term is found in the resolver taxonomy 122, the cross-reference map 124 points to the related category of “office equipment and furniture” in the associated phonebook, or initial taxonomy 112.

In some implementations, if the search term is not directly found in the resolver taxonomy 122, the resolver system 120 may then refer to relations table 128 in the resolver taxonomy 122 in order to find additional terms in the taxonomy. The relations table 128 may provide listing of broader, narrower, and related terms. For example, the next broadest term for “computer desk” could be “office furniture.” Furthermore, “office equipment and furniture” may be associated with the broader term “business supplies,” the narrower term “office furniture,” and the related term “office supplies” in relation table 128. It should be understood that this is merely an example and each search term could have other types of relations and various other terms related to it. Returning to the exemplary process, the resolver system 120 may then compare the narrower term “office furniture” (Term 2) with the terms table 126. For exemplary purposes, “office furniture” is not directly linked externally with an external code corresponding to the initial taxonomy 112 of the search portal 110.

The resolver system 120 may again refer to the relations table 128 in order to find the next broadest term relating to “office furniture” (Term 2). For example, term “office furniture” has an associated with the broader form “office equipment and furniture.” Then the resolver system 120 again may refer to the terms table 126 in order to look up “office equipment and furniture” (Term 3). For exemplary purposes, the term “office equipment and furniture” may be linked externally as indicated by an association with an external code found in the initial taxonomy 112. The above example illustrates how terms table 126 and relations table 128 are linked together to aid the cross-reference map 124 and resolver taxonomy 122. The example also illustrates how, through recursive analyze, the resolver system 120 may work through broader and broader categories until it finds an external link to a term in the initial taxonomy 112 of the search portal 110.

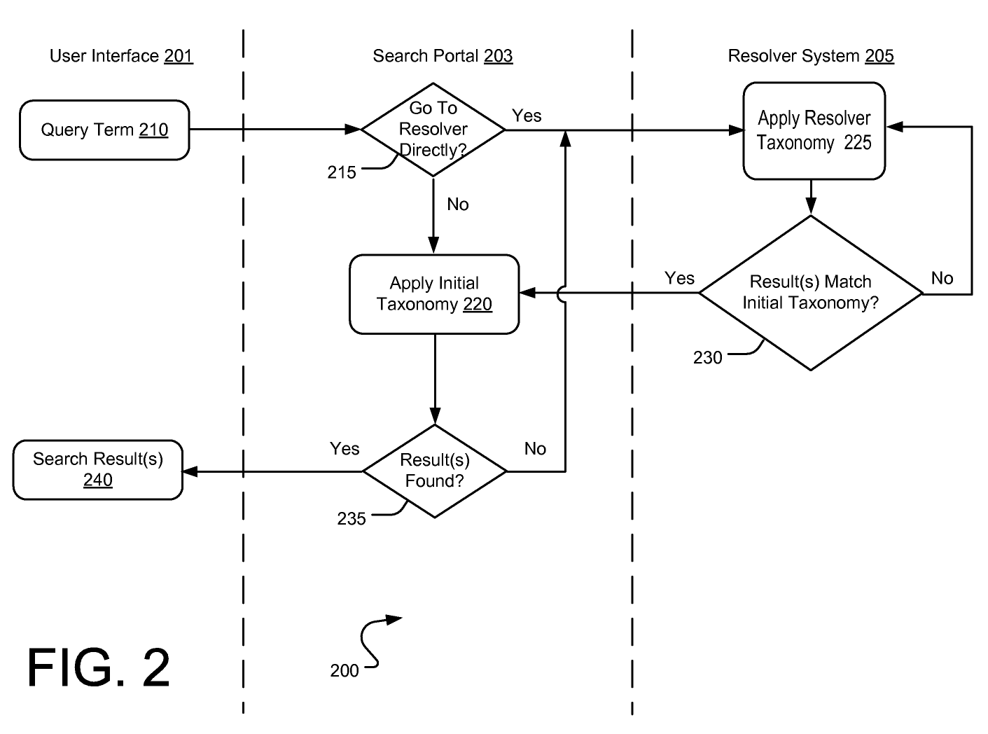

FIG. 2 is a flow chart illustrating the architecture of the query resolution service in a multiple taxonomy environment 200, which shows the interconnection of the various components introduced above, in accordance with the described teachings. FIG. 2 includes a user interface 201, a search portal 203, which includes an initial taxonomy, and a resolver system 205, which includes a resolver taxonomy and cross-reference map.

Referring to FIG. 2, at operation 210 a query term is input into a user interface 201. In the depicted implementation, the query term may be transmitted to a search portal 203. In some implementations, the query term may be transmitted directly to a resolver system 205.

At operation 215, a determination is made whether to search the search portal 203 for presence of the query term. If at operation 215, the determination is made not to search the search portal 203, then the query term is transmitted to the resolver system 205. By contrast, if at operation 215, the determination is made to search the search portal 203, then at operation 220 the initial taxonomy of the search portal 203 is searched to find the query term.

If at operation 235 the query term is found in the search portal 203, then the search result or results are transmitted to the user interface 201 at operation 240. By contrast, if at operation 235 the query term is not found in the search portal 203, then the query term is transmitted to the resolver system 205.

At operation 225, the resolver system 205 applies the resolver taxonomy to the query term to generate related terms. At operation 230, a determination is made whether the related terms generated through the resolver taxonomy match terms and/or categories in the initial taxonomy. In one implementation, this matching process is performed by a cross reference map specifically generated to relate the initial taxonomy to the resolver taxonomy.

If at operation 230, the determination is made that there is a match in the initial taxonomy, then the matching term or terms are transmitted to the search portal 203 to be applied to the initial taxonomy at operation 220. If at operation 230, the determination is made that there is not a match with the initial taxonomy, then at least one of the related terms is processed by the resolver taxonomy to generate additional related terms. The resolver system 205 then determines if these additional related terms are present in the search portal 203 at operation 230. This loop process may continue for a predefined number of iterations or until the resolver taxonomy is exhausted before the resolver system transmits back an error message. In one implementation, the resolver system 205 may transmit to the user additional suggested search terms related to resolver terms and categories to aid the user in possible search refinement.

By way of example and not limitation, a user may submit a query term searching for a “digital camera.” For illustrative purposes, the term “digital camera” is not found in the initial taxonomy of the search portal 203. The query term may then be sent to the resolver system 205. The resolver system 205 may find the query term in a category in the resolver taxonomy. The resolver system 205 may then retrieve terms from the same category relating to the query term, for example, “photographic equipment,” and “computer peripherals.” The cross-reference map may then attempt to match the retrieved term or terms to the initial taxonomy. Additionally, the resolver system 205 may provide additional query term suggestions from related resolver taxonomy categories, for example, “digital picture printing,” “smart cards,” “camera cases,” etc. The resolver system may send matching terms and additional query term suggestions back to the search portal and/or the user.

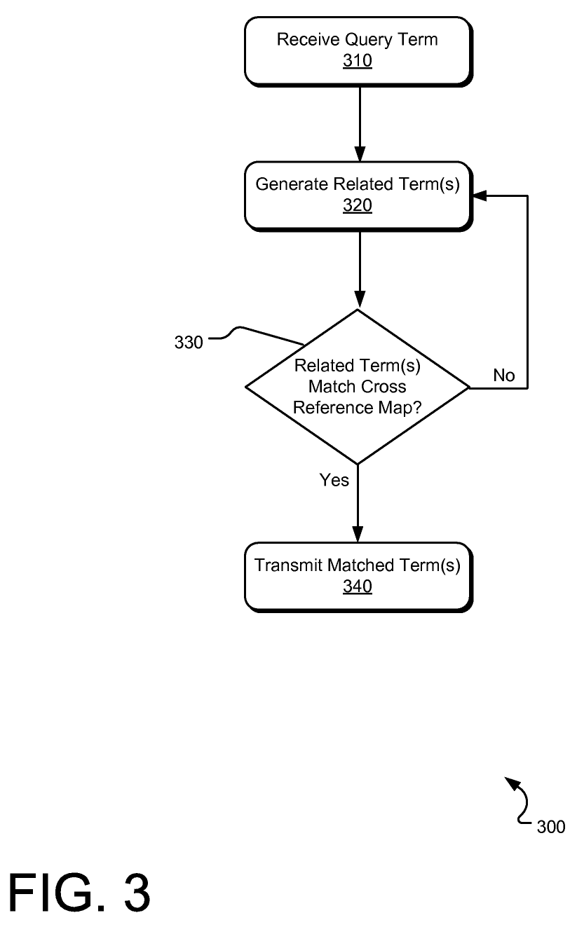

FIG. 3 is a flowchart illustrating an exemplary embodiment of the query resolution service 300 in a resolver system. At operation 310 a query term is received in the resolver system. At operation 320, the resolver system applies the resolver taxonomy to the query term to generate related terms. At operation 330, a determination is made whether the related terms generated through the resolver taxonomy match terms and/or categories in the initial taxonomy. In one implementation, this matching process is performed by a cross reference map specifically generated to relate the initial taxonomy to the resolver taxonomy.

If at operation 330, the determination is made that there is a match in the initial taxonomy, then the matching term or terms are transmitted to the search portal to be applied to the initial taxonomy. If at operation 330, the determination is made that there is not a match in the initial taxonomy, then at least one of the related terms is processed by the resolver taxonomy to generate additional terms. The resolver system then determines if these additional terms are present in the search portal at operation 330. This loop process may continue for a predefined number of iterations or until the resolver taxonomy is exhausted before the resolver system transmits back an error message.

By way of example and not limitation, assume a user provides a query term to search for a mandarin Chinese restaurant. The resolver system may locate the term “mandarin Chinese restaurant” in the resolver taxonomy and attempt to match the category with an initial taxonomy in a search portal. Continuing the example, assume the initial taxonomy does not have such a category. The resolver system may then resolve the query term to a broader term of “Chinese restaurant.” For the sake of this example, assume the initial taxonomy does not have a match for “Chinese restaurant” either. The resolver system may then further resolve the term “Chinese restaurant” to a broader term of “restaurant.” In this example, the term “restaurant” does correspond to a category in the initial taxonomy, therefore the resolver system transmits the term “restaurant” to the search portal for processing. The search portal may then search the initial taxonomy using the term “restaurant” to retrieve the content available under the category of “restaurant.” Finally, the user is presented with the content of the category, “restaurant.” The above example demonstrates how the resolver system can enhance a query term to the point that is it applicable to an initial taxonomy. In the above example, although the user may initially have been searching for a “mandarin Chinese restaurant,” with the assistance of the resolver system the user may at least have broader restaurant options displayed as a search result, instead of receiving a failed search result.

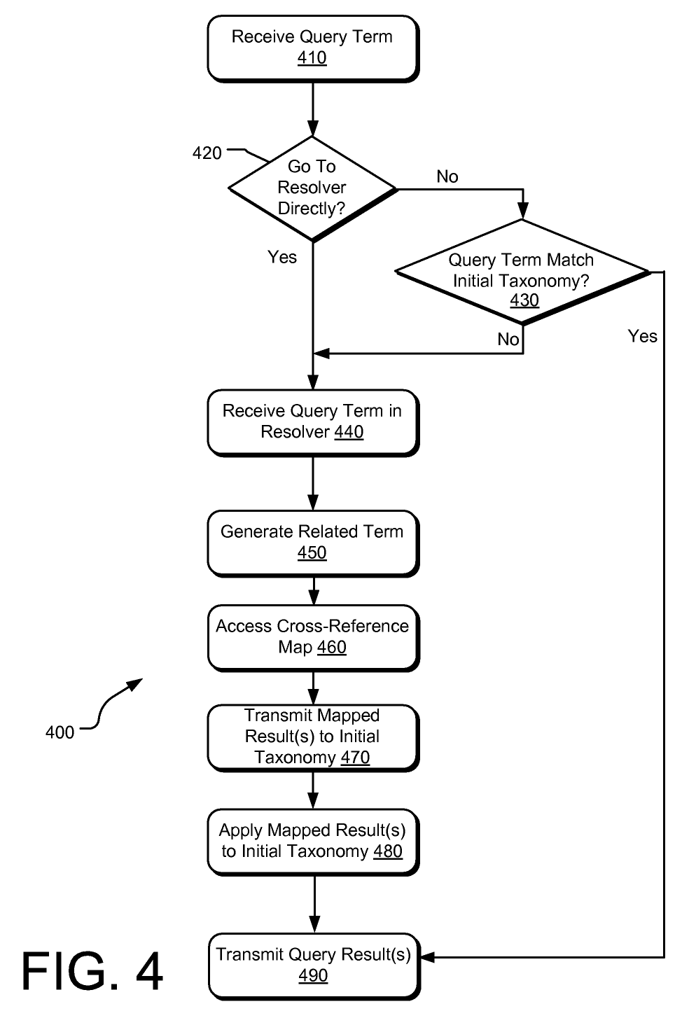

FIG. 4 is a flowchart illustrating an exemplary embodiment of the query resolution service in a multiple taxonomy environment 400. In this process, the user first submits a query of terms to a search portal at operation 410. At operation 420, a decision point is provided which allows the user or the search portal to decide whether to send the query directly to the resolver system or to first search the initial taxonomy in the search portal. If at operation 420, the decision is made to search the initial taxonomy first, the initial taxonomy is searched at operation 430. If a result is retrieved at operation 430, the result or results are transmitted to the user at operation 480.

By contrast, if no results are retrieved from the initial taxonomy at operation 430, or if the decision was made not to search the initial taxonomy at operation 420, then the query of terms is sent to and received by the resolver system at operation 440.

At operation 450, the resolver system attempts to match the query terms to a relevant resolver taxonomy category. At operation 460, the resolver system accesses a cross-reference map to look up and return the appropriate search category in the resolver taxonomy. At operation 470 the resulting category or categories are transmitted to the search portal, which then retrieves the results associated with that category at operation 480. These results are than transmitted to the user at operation 490.

In some implementations, the matching done within the resolver taxonomy may include functionalities such as, but not limited to, matching with various spellings of the query term, matching ambiguous meanings of the query term, or matching with various foreign language equivalents of the query term.

For example, in that event a user submits a foreign language query term. The search portal then sends the query term to a multi-lingual resolver, which includes a cross-reference map. In one exemplary implementation, when the search is entered in Spanish, it may be matched with the Spanish terms and then the associated English terms may be used to link to the initial taxonomy which is in English. In other words, the English language category headings in the resolver taxonomy are each mapped to a foreign language term associated with that category. Once the English language taxonomy category is identified in the resolver taxonomy, the resolver system then returns the mapped initial taxonomy category in the native language of the initial taxonomy. The search portal then retrieves the native language results associated with its taxonomy and displays them to the user. It should be noted that although the search is performed in a foreign language the results will preferably still display in the native language as defined by the search portal. As in this example, if the search were made in Spanish, the display of results would be in English because the categories in the initial taxonomy are only in English.

In another exemplary implementation, the resolver taxonomy has the ability to resolve ambiguous queries, for example, misspellings or terms that have multiple meanings. For example, assume the user is looking for an MP3 player made by Apple®. The user may submit an ambiguous query (Apple) to the search portal. Furthermore, assume the user inadvertently misspells the term (Appel). The search portal may send the ambiguous query terms to directly the resolver system. The resolver system can match the ambiguous query term to the resolver taxonomy. In order to resolve the ambiguous term the resolver system may use a cross-reference map or relation table that includes a spelling checker. In the event that an ambiguous term such as “apple” is entered, the cross-reference map or relation table may return multiple categories such as computers, music players, or fruit. Once the resolver system matches the query to the categories in the taxonomy, it returns the mapped initial taxonomy categories. Where the resolver system returns multiple taxonomy categories for an ambiguous term, those categories can be displayed to the user such that the user may choose the category for which they were actually looking. After the user selects the desired initial taxonomy category, the search portal can retrieve the results associated with that selected category and, finally, display the results to the user.

FIG. 5 illustrates an exemplary computer system that may be useful in implementing the described technology. A general purpose computer system 500 is capable of executing a computer program product to execute a computer process. Data and program files may be input to the computer system 500, which reads the files and executes the programs therein. Some of the elements of a general purpose computer system 500 are shown in FIG. 5 wherein a processor 502 is shown having an input/output (I/O) section 504, a central processing unit (CPU) 506, and a memory section 508. There may be one or more processors 502, such that the processor 502 of the computer system 500 comprises a single central-processing unit 506, or a plurality of processing units, commonly referred to as a parallel processing environment. The computer system 500 may be a conventional computer, a distributed computer, a server computer, or any other type of computer. The described technology is optionally implemented in software devices loaded in memory 508, stored on a configured DVD/CD-ROM 510 or storage unit 512, and/or communicated via a wired or wireless network link 514 on a carrier signal, thereby transforming the computer system 500 in FIG. 5 to a special purpose machine for implementing the described operations.

The I/O section 504 is connected to one or more user-interface devices (e.g., a keyboard 516 and a display unit 518), a disk storage unit 512, and a disk drive unit 520. Generally, in contemporary systems, the disk drive unit 520 is a DVD/CD-ROM drive unit capable of reading the DVD/CD-ROM medium 510, which typically contains programs and data 522. Computer program products containing mechanisms to effectuate the systems and methods in accordance with the described technology may reside in the memory section 504, on a disk storage unit 512, or on the DVD/CD-ROM medium 510 of such a system 500. Alternatively, a disk drive unit 520 may be replaced or supplemented by a floppy drive unit, a tape drive unit, or other storage medium drive unit. The network adapter 524 is capable of connecting the computer system to a network via the network link 514, through which the computer system can receive instructions and data embodied in a carrier wave. Examples of such computer systems 500 include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as personal digital assistants (PDAs), mobile phones, gaming consoles, set top boxes, etc.

When used in a LAN-networking environment, the computer system 500 is connected (by wired connection or wirelessly) to a local network through the network interface or adapter 524, which is one type of communications device. When used in a WAN-networking environment, the computer system 500 typically includes a modem, a network adapter, or any other type of communications device for establishing communications over the wide area network. In a networked environment, program modules depicted relative to the computer system 500 or portions thereof, may be stored in a remote memory storage device. It is appreciated that the network connections shown are exemplary and other means of and communications devices for establishing a communications link between the computers may be used.

In an exemplary implementation, the resolver taxonomy, the cross reference map, and other modules may be incorporated as part of the operating system, application programs, or other program modules of the computer. Orders logs, products databases, user databases, order code databases, transaction logs, and other data may be stored as program data.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts described above. Rather, the specific features and acts described above are disclosed as example forms of implementing the claimed subject matter.

What is claimed is:

1. A method to resolve queries, the method comprising:
receiving a query term from a search portal, the search portal including an initial taxonomy;
matching the query term to a first resolver category within a resolver taxonomy;
retrieving a first resolver term from the first resolver category matching the query term;
determining if the first resolver term corresponds to a first mapping term in a mapping module, the first mapping term corresponding to at least one search category in the initial taxonomy; and
transmitting, to the search portal, an identification of the corresponding search category within the initial taxonomy, which is mapped to the resolver taxonomy through the first mapping term, upon a determination that the first resolver term corresponds to the first mapping term.

2. The method of claim 1 further comprising:
retrieving a second resolver term from a second resolver category, the second resolver category relationally associated with the first resolver category, upon a determination that the first resolver term does not correspond to the first mapping term;
determining if the second resolver term corresponds to a second mapping term in the mapping module, the second mapping term corresponding to at least one search category in the initial taxonomy; and
transmitting, to the search portal, an identification of a corresponding search category within the initial taxonomy, which is mapped to the resolver taxonomy through the second mapping term, upon a determination that the second resolver term corresponds to the second mapping term.

3. The method of claim 1 further comprising:
matching the query term to a second resolver category within the resolver taxonomy;
retrieving a second resolver term from a second resolver category matching the query term;
determining if the first resolver term corresponds to a first mapping term and if the second resolver term corresponds to a second mapping term in a mapping module; and
transmitting an identification of a corresponding first search category within an initial taxonomy which is mapped to the first resolver term and an identification of a corresponding second search category within the initial taxonomy, which is mapped to the second resolver term upon a determination that the first resolver term corresponds to the first mapping term and the second resolver term corresponds to the second mapping term.

4. The method of claim 1, wherein the operation of receiving a query term comprises
receiving the query term from a search portal upon a determination by the search portal that the query term is not located within a search category of an initial taxonomy.

5. The method of claim 1 further comprising
transmitting an identification of at least one additional term from the first resolver category relationally associated to the retrieved term from the first resolver category.

6. The method of claim 1, wherein the first resolver category comprises
at least one term that is a variation on the spelling of the query term.

7. The method of claim 1, wherein the first resolver category comprises
at least one term that is a foreign language spelling of the query term.

8. A computer-readable storage medium encoding a computer program for executing on a computer system a computer process to resolve queries, the computer process comprising:
receiving a query term from a search portal, the search portal including an initial taxonomy;
matching the query term to a first resolver category within a resolver taxonomy;
retrieving a first resolver term from the first resolver category matching the query term;
determining if the first resolver term corresponds to a first mapping term in a mapping module, the first mapping term corresponding to at least one search category in the initial taxonomy; and
transmitting, to the search portal, an identification of the corresponding search category within the initial taxonomy, which is mapped to the resolver taxonomy through the first mapping term, upon a determination that the first resolver term corresponds to the first mapping term.

9. The computer-readable storage medium of claim 8 further comprising:
retrieving a second resolver term from a second resolver category, the second resolver category relationally associated with the first resolver category, upon a determination that the first resolver term does not correspond to the first mapping term;
determining if the second resolver term corresponds to a second mapping term in the mapping module, the second mapping term corresponding to at least one search category in the initial taxonomy; and
transmitting, to the search portal, an identification of a corresponding search category within the initial taxonomy, which is mapped to the resolver taxonomy through the second mapping term, upon a determination that the second resolver term corresponds to the second mapping term.

10. The computer-readable storage medium of claim 8 further comprising:
matching the query term to a second resolver category within the resolver taxonomy;
retrieving a second resolver term from a second resolver category matching the query term;
determining if the first resolver term corresponds to a first mapping term and if the second resolver term corresponds to a second mapping term in a mapping module; and
transmitting an identification of a corresponding first search category within an initial taxonomy which is mapped to the first resolver term and an identification of a corresponding second search category within the initial taxonomy, which is mapped to the second resolver term upon a determination that the first resolver term corresponds to the first mapping term and the second resolver term corresponds to the second mapping term.

11. The computer-readable storage medium of claim 8, wherein receiving a query term comprises
receiving the query term from a search portal upon a determination by the search portal that the query term is not located within a search category of an initial taxonomy.

12. The computer-readable storage medium of claim 8 further comprising
transmitting an identification of at least one additional term from the first resolver category relationally associated to the retrieved term from the first resolver category.

13. The computer-readable storage medium of claim 8, wherein the first resolver category comprises
at least one term that is a variation on the spelling of the query term.

14. The computer-readable storage medium of claim 8, wherein the first resolver category comprises
at least one term that is a foreign language spelling of the query term.

15. A query resolution system comprising:
a memory module;
a resolver taxonomy stored in the memory module, the resolver taxonomy including at least two relationally associated resolver categories; and
a processor communicatively coupled to the memory module operable to:
receive a query term from a search portal, the search portal including an initial taxonomy;
match the query term to a first resolver category within a resolver taxonomy;
retrieve a first resolver term from the first resolver category matching the query term;
determine if the first resolver term corresponds to a first mapping term in a mapping module, the first mapping term corresponding to at least one search category in the initial taxonomy; and
transmit, to the search portal, an identification of the corresponding search category within the initial taxonomy, which is mapped to the resolver taxonomy through the first mapping term, upon a determination that the first resolver term corresponds to the first mapping term.

16. The system of claim 15 wherein the processor is further operable to:
retrieve a second resolver term from a second resolver category, the second resolver category relationally associated with the first resolver category, upon a determination that the first resolver term does not correspond to the first mapping term;
determine if the second resolver term corresponds to a second mapping term in the mapping module, the second mapping term corresponding to at least one search category in the initial taxonomy; and
transmit, to the search portal, an identification of a corresponding search category within the initial taxonomy, which is mapped to the resolver taxonomy through the second mapping term, upon a determination that the second resolver term corresponds to the second mapping term.

17. The system of claim 15, wherein the processor is further operable to:
match the query term to a second resolver category within the resolver taxonomy;
retrieve a second resolver term from a second resolver category matching the query term;
determine if the first resolver term corresponds to a first mapping term and if the second resolver term corresponds to a second mapping term in a mapping module; and
transmit an identification of a corresponding first search category within an initial taxonomy which is mapped to the first resolver term and an identification of a corresponding second search category within the initial taxonomy, which is mapped to the second resolver term upon a determination that the first resolver term corresponds to the first mapping term and the second resolver term corresponds to the second mapping term.

18. The system of claim 15, wherein the processor is further operable to:
receive the query term from a search portal upon a determination by the search portal that the query term is not located within a search category of an initial taxonomy.

19. The system of claim 15 wherein the processor is further operable to:
transmit an identification of at least one additional term from the first resolver category relationally associated to the retrieved term from the first resolver category.

20. The system of claim 15, wherein a resolver category comprises
at least one term that is a variation on the spelling of the query term.

21. The system of claim 15, wherein a resolver category comprises
at least one term that is a foreign language spelling of the query term.
